(19) United States
(12) Patent Application Publication
(10) Pub. No.: US 2025/0168056 A1
(43) Pub. Date: May 22, 2025

(54) INTELLIGENT ANOMALY DETECTION AND RECOMMENDATION SYSTEMS

(71) Applicant: TWILIO INC., San Francisco, CA (US)

(72) Inventors: Michael Lasso, San Francisco, CA (US); Darya Shcharbinskaya, San Francisco, CA (US); Jiahui Cai, San Francisco, CA (US); Alireza Farasat, San Francisco, CA (US); Dmitry Rusanovsky, San Francisco, CA (US); Amit Mahajan, San Francisco, CA (US); Joshua Ramsden-Pogue, San Francisco, CA (US); Mariana Simona Mihai, San Francisco, CA (US); Peter Janovsky, San Francisco, CA (US)

(21) Appl. No.: 18/510,982

(22) Filed: Nov. 16, 2023

(51) Int. Cl. H04L 41/0659; H04L 41/0604; H04L 43/062; H04L 43/16

(52) U.S. Cl. CPC H04L 41/0661; H04L 41/0622; H04L 43/062; H04L 43/16

(57) ABSTRACT

A computing device can identify an anomaly based on metadata associated with network traffic messages corresponding to a particular account. After identifying the anomaly, the computing device can determine a failure score for the network traffic messages representing a failure rate for the message traffic. The computing device can determine a fluctuation score by comparing the network traffic messages in a current time period to a previous time period. The computing device can determine a sparsity score by analyzing the message traffic in a previous period of time. The computing device can generate an anomaly impact score based on the failure score, the fluctuation score, and the sparsity score and assign the anomaly to a severity bin based on the anomaly impact score.

### TECHNICAL FIELD

The present systems and processes relate to anomalies in network traffic message failures, delays, and trends.

### BACKGROUND

Users can send network traffic messages to thousands or millions of recipients at once. Network traffic messages (e.g., SMS messages, emails, messages via a messaging application system, phone calls) allow for users to contact multiple clients at once. Network traffic messages can fail to send or transmit or be delivered to the intended recipients for any number of reasons: the intended recipient being unreachable or unknown (e.g., the phone number or email is incorrect or has been disconnected or disabled or the recipient is unable to receive network traffic messages), the recipient has blocked the sender, network traffic messages are categorized as spam, or unknown errors. Network traffic messages can also delay sending or transmitting. Further, network traffic messages can include irregular or atypical patterns (e.g., irregular volume or changes in volume, irregular time).

Errors can be generated for every failed network traffic message. Errors can number into the thousands and be time-intensive to monitor. Users can experience difficulty prioritizing the most severe errors. The most severe errors, which may occur infrequently, can be characterized as anomalies. Therefore, there is a long-felt but unresolved need for identifying anomalies in real-time, traffic data and notifying users.

### BRIEF SUMMARY OF THE DISCLOSURE

Briefly described, and according to one embodiment, aspects of the present disclosure generally relate to identifying anomalies based on network traffic message failures. Network traffic messages can be transmitted or sent to multiple recipients. The network traffic messages can include SMS messages, emails, messages via a messaging application system, audio calls, etc. As will be understood by one having ordinary skill in the art, network traffic messages can fail to send, transmit, or be delivered to the intended recipients. When a network traffic message fails, an error can be generated. The disclosed anomaly detection system can identify anomalies based on the generated errors, delays in network traffic messages, and trends (e.g., trends relating to the volume, changes in volume, and timing of network traffic messages, failures, and errors). Anomalies can be a volume or number of errors exceeding a baseline or threshold. Anomalies can indicate the severity of the errors and assist users with prioritizing certain errors over others.

When the number of network traffic message failures exceeds an anomaly threshold during a period of time, an anomaly can be identified. The anomaly threshold can be a statistically significant quantity of network traffic message failures over a period of time. After an anomaly is identified, the system can calculate a failure score, a fluctuation score, and a sparsity score for the anomaly. The failure score can indicate the error or failure rate (e.g., the rate of network traffic message failures) against the historical error or failure rate. The fluctuation score can indicate the difference between the current network traffic messages and the previous network traffic messages. The sparsity score can indicate the number of previous network traffic messages from a previous period of time. The failure score, the fluctuation score, and the sparsity score can be weighted to generate an anomaly impact score. The anomaly impact score can be an anomaly severity score and indicate the severity of the anomaly (e.g., the number of traffic message failures, errors that limit the ability of the user to send or transmit network traffic messages to recipients). The anomalies can be assigned to a severity bin based on the scores. The severity bins can be impact bins. The system can generate and send notifications to users regarding the anomaly based on the scores and assigned severity bin. The system can generate recommendations to address and remedy the anomalies.

A machine learning model or algorithm can be trained to identify anomalies. The model can be trained using previous network traffic messages, previously identified anomalies, and user feedback. The machine learning model can be applied to current network traffic messages to identify anomalies.

The above and further features of the disclosed systems and methods will be recognized from the following detailed descriptions and drawings of various embodiments.

### BRIEF DESCRIPTION OF THE FIGURES

The accompanying drawings illustrate one or more embodiments and/or aspects of the disclosure and, together with the written description, serve to explain the principles of the disclosure. Wherever possible, the same reference numbers are used throughout the drawings to refer to the same or like elements of an embodiment, and wherein:

FIG. 1 illustrates an exemplary error feed according to various embodiments of the present disclosure.

FIG. 2A illustrates an exemplary error chart according to various embodiments of the present disclosure.

FIG. 2B illustrates an exemplary error chart according to various embodiments of the present disclosure.

FIG. 3 illustrates an exemplary networked environment for the disclosed system according to various embodiments of the present disclosure.

FIG. 4 illustrates an exemplary overall process for the disclosed system according to various embodiments of the present disclosure.

FIG. 5 illustrates an exemplary process for training a machine learning algorithm to identify anomalies according to various embodiments of the present disclosure.

### DETAILED DESCRIPTION

For the purpose of promoting an understanding of the principles of the present disclosure, reference will now be made to the embodiments illustrated in the drawings and specific language will be used to describe the same. It will, nevertheless, be understood that no limitation of the scope of the disclosure is thereby intended; any alterations and further modifications of the described or illustrated embodiments, and any further applications of the principles of the disclosure as illustrated therein are contemplated as would normally occur to one skilled in the art to which the disclosure relates. All limitations of scope should be determined in accordance with and as expressed in the claims.

Whether a term is capitalized is not considered definitive or limiting of the meaning of a term. As used in this document, a capitalized term shall have the same meaning as an uncapitalized term, unless the context of the usage specifically indicates that a more restrictive meaning for the capitalized term is intended. However, the capitalization or lack thereof within the remainder of this document is not intended to be necessarily limiting unless the context clearly indicates that such limitation is intended.

### Overview

Aspects of the present disclosure generally relate to identifying anomalies based on network traffic message failures. Network traffic messages can be transmitted or sent to multiple recipients. The network traffic messages can include SMS messages, emails, messages via a messaging application system, or audio calls. The recipients can be any network traffic destination including phone numbers, email addresses, usernames or handles for a messaging application system, or any other network traffic destination capable of receiving network traffic messages. As will be understood by one having ordinary skill in the art, network traffic messages can fail to send, transmit, or be delivered to the intended recipients. Network traffic messages can fail for various reasons including the intended recipient being unreachable or unknown (e.g., the phone number or email is incorrect or has been disconnected or disabled or the recipient is unable to receive network traffic messages), the recipient has blocked the sender, network traffic messages are categorized as spam, or unknown errors.

When a network traffic message fails, an error can be generated (e.g., the record of the error can be generated, including an error code). Reviewing each individual error can be time-intensive and users can have difficulty prioritizing certain errors over other errors. The disclosed anomaly detection system can indicate the severity of errors and notify users when errors are anomalies. As will be understood by one having ordinary skill in the art and to be discussed in further detail, anomalies can be a volume or number of errors exceeding a baseline or threshold. Because the disclosed system can indicate the severity of errors or anomalies, users can prioritize addressing or remedying the most severe errors (e.g., a high volume or number of errors, errors that limit the ability of the user to send or transmit network traffic messages to recipients).

When the number of network traffic message failures exceeds an anomaly threshold during a period of time, an anomaly can be identified. The anomaly threshold can be a statistically significant quantity of network traffic message failures over a period of time. The anomaly threshold can be configured for each user, account, or error type. The anomaly can be identified based on the user, the one or more accounts associated with a user, the error, and the metadata associated with the network traffic failure (e.g., the number of the network traffic failure, the time period of the network traffic failures).

A failure score, a fluctuation score, and a sparsity score can be calculated for the identified anomaly. The failure score can be the number of network traffic message failures compared to the total number of network traffic messages during a time period. The fluctuation score can be the total number of network traffic messages in a current or recent time period compared to a number of network traffic messages from a previous time period. The sparsity score can represent the number of network traffic messages from a previous period of time. The failure score, the fluctuation score, and the sparsity score (collectively the “sub-scores”) can be a rate represented by a number (e.g., 0 to 1) or a percentage (e.g., 0% to 100%). The failure score, the fluctuation score, and the sparsity score (collectively the “sub-scores”) can be weighted to generate an anomaly score. The sub-scores can be weighted equally, unequally, or weighted based on a user or account configuration. The anomaly score can indicate the severity of the anomaly (e.g., the number of traffic message failures, errors that limit the ability of the user to send or transmit network traffic messages to recipients).

The anomalies can be assigned to a severity bin based on the anomaly impact score and the sub-scores. The severity bins can indicate the severity of the assigned anomalies. As an example, four severity bins can represent urgent, critical, important, and warning severity levels. The severity bins can allow users to quickly understand the severity of the identified anomalies and prioritize anomalies in the bin with the highest severity.

The system can generate and send a notification regarding the anomaly to users or one or more accounts associated with a user. Users can configure notification settings based on their preferences. For example, a user can configure the notification settings to only generate and send notifications for anomalies assigned to the urgent severity bin. As another example, a user can configure the notification settings to only generate and send notifications if the anomaly impact score falls within a certain range. The notification can include metadata associated with the anomaly, the assigned severity bin, the anomaly impact score, and the sub-scores.

The system can identify and modify a configuration property as a remedial action. The configuration property can include any property or parameter associated with one or more network traffic messages. The configuration property can include a filter setting, a network traffic message schedule, a network traffic message sender (e.g., the phone number, email address, or account that will send or transmit the network traffic message), or the recipients (e.g., specific recipients, number of recipients). The configuration property can cause, resolve, or be related to the network traffic message failures, errors, or anomalies.

The system can train a machine learning model or algorithm to identify anomalies. The machine learning model can be trained based on historical data (e.g., data associated with previous network traffic messages). The historical data can be labeled to indicate anomalies. The machine learning model can be a classification model capable of classifying anomalies and regularities. The machine learning model can determine the anomaly threshold and weigh the sub-scores.

### Exemplary Embodiments

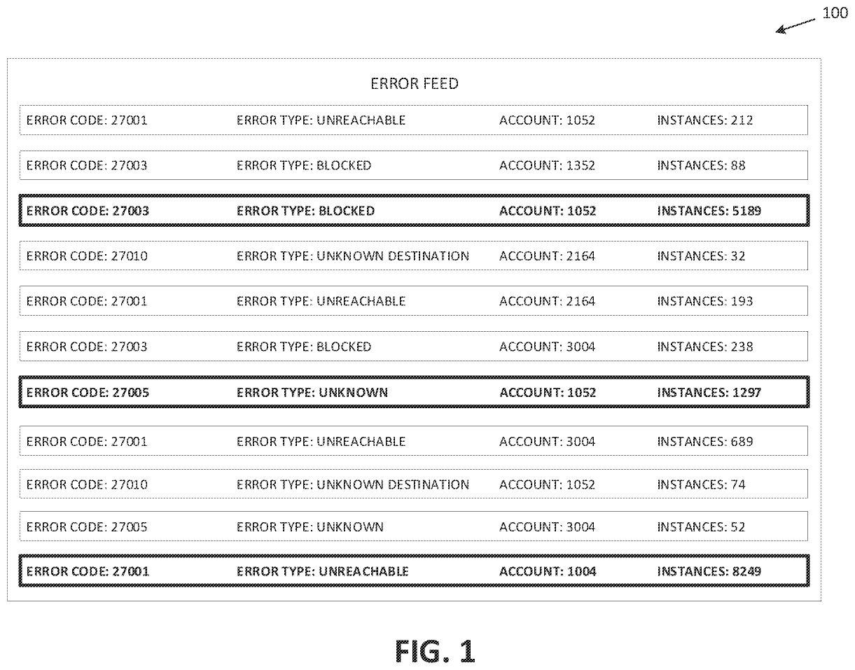

Referring now to the figures, for the purposes of example and explanation of the fundamental processes and components of the disclosed systems and processes, reference is made to FIG. 1, which illustrates an exemplary error feed 100 of the disclosed anomaly detection system.

As will be understood by one having ordinary skill in the art, users of the disclosed system can send or transmit network traffic messages to one or more recipients. The network traffic messages can include SMS messages, emails, messages via a messaging application system, or audio calls. The recipients can be any network traffic destination including phone numbers, email addresses, usernames or handles for a messaging application system, or any other network traffic destination capable of receiving network traffic messages. Users of the disclosed system can send or transmit network traffic messages to multiple recipients at once (e.g., 50 recipients, 1,000 recipients, 10,000 recipients, 100,000 recipients, 1,000,000 recipients). As will be understood by one having ordinary skill in the art, network traffic messages can fail to send or transmit to the intended recipients. Network traffic messages can fail to be delivered or received by the intended recipients. Network traffic messages can fail for various reasons including the intended recipient being unreachable or unknown (e.g., the phone number or email is incorrect or has been disconnected or disabled or the recipient is unable to receive network traffic messages), the recipient has blocked the sender, network traffic messages are categorized as spam, or unknown errors.

When a network traffic message fails to send or transmit to a recipient or fails to be delivered or received by a recipient, the disclosed system can receive or determine an error associated with the failure. An error can be any instance when the disclosed system attempts to send or transmit a network traffic message to a recipient and the network traffic message fails to send or be delivered to the recipient. The error can include error metadata associated with the error including an error code (e.g., an alphanumeric code associated with the error), an error type (e.g., recipient unreachable, sender blocked, unknown destination, spam, landline, carrier error, filter error, unknown error), an account (e.g., an account associated with a user sending or transmitting the network traffic messages), and instances (e.g., the number of failed network traffic messages). The errors and the associated metadata can be displayed on the error feed 100 associated with a particular user or account. Any user can have one or more accounts.

The error feed 100 can include multiple errors. The error feed 100 can include a significant volume of errors (e.g., hundreds, thousand, or more) and monitoring the error feed 100 can be time-intensive. A user may experience difficulty prioritizing certain errors over other errors (e.g., difficulty prioritizing which errors should be addressed or remedied before other errors) and the user may have trouble knowing whether a certain error can wait or should be urgently addressed. As an example, the error feed 100 can indicate account 1052 has 5,189 instances of error code 27003 and 1,297 instances of error code 27005.

The disclosed system can notify users when an anomalous pattern occurs in error codes with different levels of severity. As will be understood by one having ordinary skill in the art and to be discussed in further detail, anomalies can be a volume or number of errors exceeding a baseline or threshold. Because the disclosed system can indicate the severity of errors or anomalies, users can prioritize addressing or remedying the most severe errors (e.g., a high volume or number of errors, errors that limit the ability of the user to send or transmit network traffic messages to recipients). The disclosed system can perform remedial actions to address the errors. As will be understood and appreciated, the disclosed system represents merely one approach or embodiment of the present system, and other aspects are used according to various embodiments of the present system.

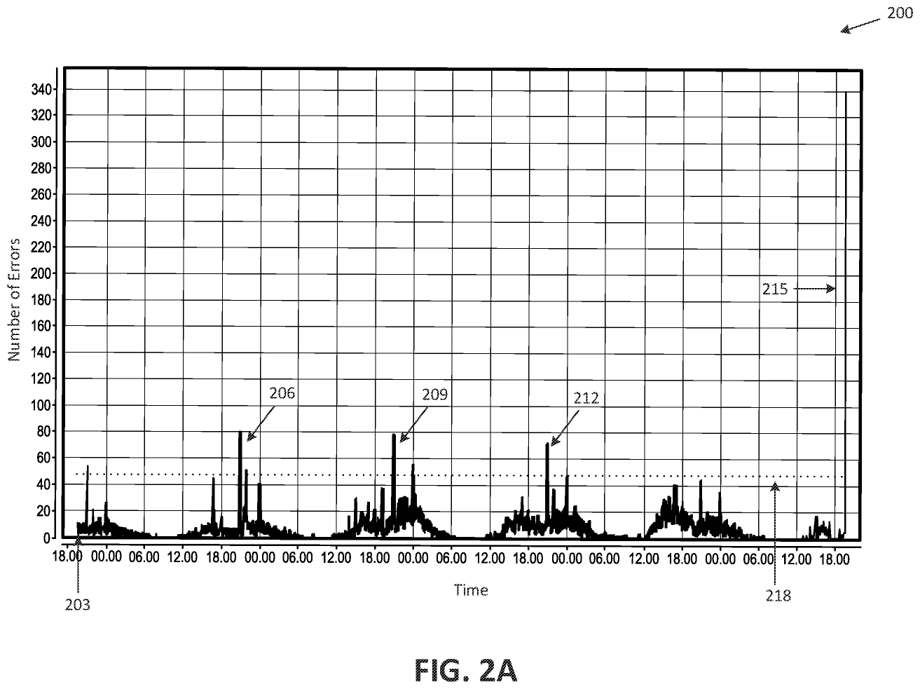

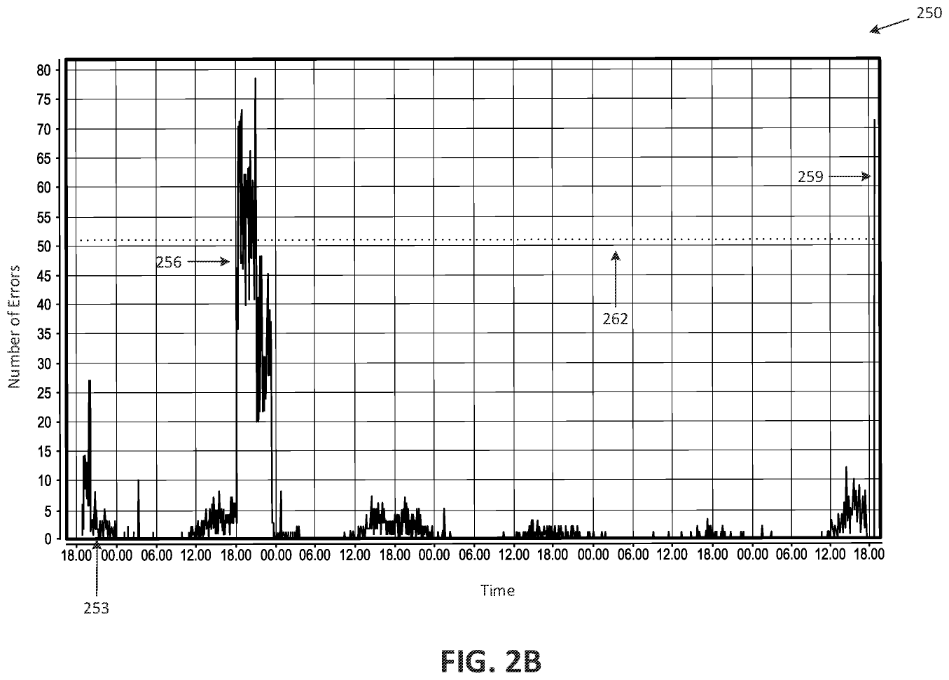

Referring now to FIG. 2A, shown is an exemplary error chart 200. The error chart 200 can provide a graphical representation of anomalies. As will be understood by one having ordinary skill in the art, an anomaly can be a number of errors exceeding a threshold or baseline. The threshold or baseline can be a statistically significant number of errors, such as an average or median number of errors over time. The system can determine the threshold or baseline dynamically and updated the statistically significant value. As an example, an anomaly can be a number of errors meeting or exceeding a statistically significant quantity of errors calculated as a variance from an average or median number of errors, such as by one or more standard deviations from an average. As another example, an anomaly can be any number of errors exceeding an average or median number of errors. The statistically significant quantity of errors can be calculated over a period of time (e.g., 1 minute, 5 minutes, 60 minutes, 1 hour, 72 hours, or 336 hours). As an example, an anomaly can be a certain number of errors received during a period of time (e.g., 15 seconds, 1 minute, 5 minutes, 10 minutes, 60 minutes, 1 hour, or 24 hours) that exceeds the statistically significant quantity of errors calculated over a longer period of time.

The error chart 200 can have an X axis indicating time. Time can be marked cumulatively (e.g., total time elapsed) or as a time stamp (e.g., time of day). The error chart 200 can have a Y axis indicating the number or errors. The line 203 indicates the number of errors at a certain point in time. The line 203 can include multiple spikes (e.g., increases in the number of errors) include spikes 206, 209, 212, and 215. The dashed line 218 can indicate the statistically significant quantity of errors over time. As will be understood and appreciated, the spikes 206, 209 and 212 can exceed the dashed line 218 (e.g., the statistically significant quantity of errors over time) by about 15 to 20 errors. However, the spike 215 can exceed the dashed line 218 by hundreds of errors. As an example, the spike 215 can indicate an anomaly (e.g., a number of errors exceeding the statistically significant quantity of errors over time). The spike 215 can indicate an anomaly with a volume of errors in a short period of time that exceed the threshold at dashed line 218. As another example, the spikes 206, 209, 212 and 215 can indicate anomalies.

Referring now to FIG. 2B, shown is an exemplary error chart 250. The error chart 250 can provide a graphical representation of anomalies. The error chart 250 can have an X axis indicating time. Time can be marked cumulatively (e.g., total time elapsed) or as a time stamp (e.g., time of day). The error chart 250 can have a Y axis indicating the number or errors. The line 253 indicates the number of errors at a certain point in time. The line 253 can include multiple spikes (e.g., increases in the number of errors) include spikes 256 and 259. The dashed line 262 can indicate the statistically significant quantity of errors over time. As an example, the spikes 256 and 259 can represent anomalies. The spike 259 can indicate an anomaly with dozens of errors in a short period of time. The spike 256 can indicate an anomaly with hundreds of errors over several hours. As will be understood and appreciated, the anomaly represented by the spike 256 can be more persistent (e.g., occur over a longer period of time) than the anomaly represented by the spike 259.

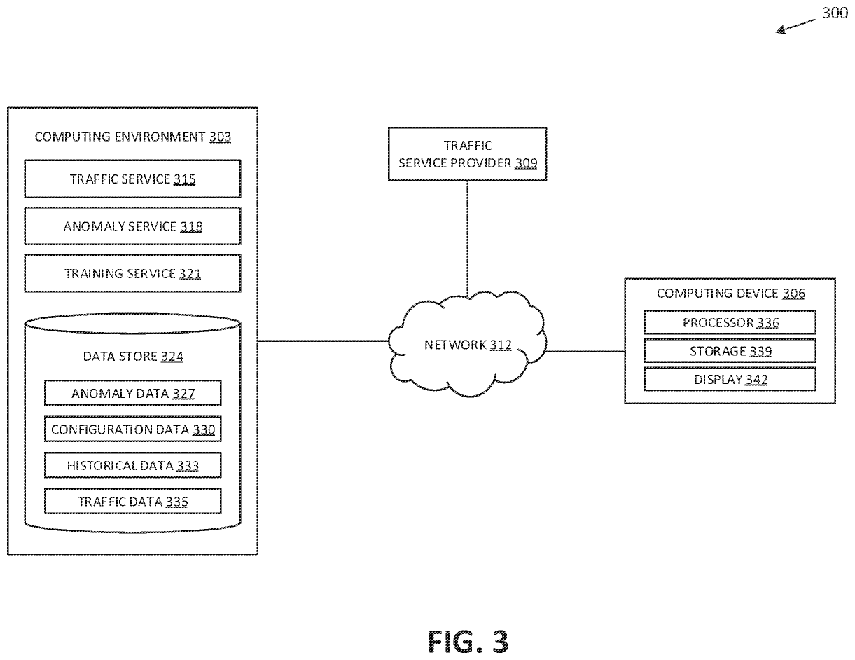

Referring now to FIG. 3, shown is an exemplary networked environment 300 for the anomaly detection system according to various embodiments of the present disclosure. As will be understood and appreciated, the exemplary networked environment 300 shown in FIG. 3 represents merely one approach or embodiment of the present system, and other aspects are used according to various embodiments of the present system. Exemplary networked environment 300 can include, but is not limited to, a computing environment 303 connected to one or more computing devices 306 and a traffic service provider 309 over a network 312.

The elements of the computing environment 303 can be provided via one or more computing devices that may be arranged, for example, in one or more server banks or computer banks or other arrangements. Such computing devices can be located in a single installation or may be distributed among many different geographical locations. For example, the computing environment 303 can include one or more computing devices that together may include a hosted computing resource, a grid computing resource, or any other distributed computing arrangement. In some cases, the computing environment 303 can correspond to an elastic computing resource where the allotted capacity of processing, network, storage, or other computing-related resources may vary over time. Regardless, the computing environment 303 can include one or more processors and memory having instructions stored thereon that, when executed by the one or more processors, cause the computing environment 303 to perform one, some, or all of the actions, methods, steps, or functionalities provided herein.

The computing environment 303 can include a traffic service 315, an anomaly service 318, a training service 321, and a data store 324. The traffic service 315, the anomaly service 318, and the training service 321 can correspond to one or more software executables that can be executed by the computing environment 303 to perform the functionality described herein. While the traffic service 315, the anomaly service 318, and the training service 321 are described as different services, it can be appreciated that the functionality of these services can be implemented in one or more different services executed in the computing environment 303. Various data can be stored in the data store 324, including but not limited to, the anomaly data 327, the configuration data 330, the historical data 333, and the traffic data 335.

The traffic service 315 can allow a user or an account to send or transmit network traffic messages to recipients. The traffic service 315 can schedule or queue network traffic messages for intended recipients. The network traffic messages, including the queued, scheduled, and previously sent messages, can be stored as the data store 324 as the traffic data 335. For example, network traffic messages can be queued for sending over a period of time. For example, network traffic messages can be sent in real time. If a network traffic message fails, the traffic service 315 can receive or determine an error associated with the failure. The error can include metadata associated with the error including an error code (e.g., an alphanumeric code associated with the error), an error type (e.g., recipient unreachable, sender blocked, unknown destination, spam, landline, carrier error, filter error, unknown error), an account (e.g., an account associated with a user sending or transmitting the network traffic messages), and instances (e.g., the number of failed network traffic messages).

When network traffic messages fail, the traffic service 315 can determine if the number of failed network traffic messages exceeds an anomaly threshold. The anomaly threshold can be a statistically significant quantity of network traffic message failures over a period of time. The statistically significant quantity of network traffic message failures can be calculated over a period of time (e.g., 1 minute, 5 minutes, 60 minutes, 1 hour, 72 hours, or 336 hours). The anomaly threshold can be associated for each user, each account, each error type (e.g., recipient unreachable, sender blocked, unknown destination, spam, landline, carrier error, filter error, or unknown error) or each error code. The anomaly threshold can be calculated based on at least the anomaly data 327, the historical data 333, and the traffic data 335. The anomaly threshold can be received as an input from a user for one or more accounts associated with the user. The anomaly threshold can be determined by the machine learning algorithms. The number of network traffic message failures can simply exceed the anomaly threshold (e.g., the number of network traffic message failures is greater than the anomaly threshold), exceed the anomaly threshold by one or more standard deviations, or exceed the anomaly threshold by a specified difference.

The traffic service 315 can determine if the network traffic message failures exceeds the anomaly threshold within a period of time. For example, the traffic service 315 can determine if the number of network traffic message failures exceeds the anomaly threshold in a 5 minute time period. As another example, the traffic service 315 can determine if the number of network traffic message failures exceeds the anomaly threshold in a 1 hour time period. The traffic service 315 can determine the difference between the number of traffic message failures and the anomaly threshold.

The anomaly service 318 can identify anomalies, calculate scores associated with anomalies, and assign anomalies to a severity bin. If the traffic service 315 determines that the network traffic message failures exceeds the anomaly threshold, the anomaly service 318 can identify the anomaly. The anomaly service 318 can identify the anomaly based on the user or account associated with network traffic message failures. The anomaly service 318 can identify the anomaly based on the error type (e.g., recipient unreachable, sender blocked, unknown destination, spam, landline, carrier error, filter error, unknown error) or error code. The anomaly service 318 can identify the anomaly based on the metadata associated with the network traffic failure (e.g., the number of the network traffic failure, the time period of the network traffic failures). The anomaly service 318 can identify the anomaly based on delays in network traffic messages (e.g., delays in the sending, delivery, or receipt of the network traffic messages). The anomaly service 318 can identify the anomaly based on trends (e.g., patterns in the historic data or current or ongoing network traffic messages relating to volume, changes in volume, and timing of network traffic messages, failures, and errors). The identified anomaly can be stored in the data store 324 as the anomaly data 327.

The anomaly service 318 can calculate the failure score, the fluctuation score, and the sparsity score associated with the anomaly. The failure score can be the number of network traffic message failures compared to the total number of network traffic messages during a time period. The failure score can be the number of network traffic message failures compared to the number of network traffic message failures in the historical data 333. The fluctuation score can be the total number of network traffic messages in a time period. The fluctuation score can be the total number of network traffic messages in a current or recent time period compared to a number of network traffic messages from the historical data 333 (e.g., the total number of network traffic messages are from a current or recent time period and is compared to a number of network traffic messages from a previous or earlier time period). The fluctuation score can represent an amount of data sent or transmitted by a user or account. The sparsity score can represent the number of network traffic messages from a previous period of time. The sparsity score can represent the number of network traffic messages from the historical data 333. The sparsity score can represent an amount of data sent or transmitted by a user or account during the previous period of time. The sparsity score can represent an amount of data sent or transmitted by a user or account. The failure score, the fluctuation score, and the sparsity score (collectively the “sub-scores”) can be a rate represented by a number (e.g., 0 to 1) or a percentage (e.g., 0% to 100%). The anomaly service 318 can determine the sub-scores for each user, account, error type, and/or time period.

The anomaly service 318 can generate an anomaly impact score based on the sub-scores. The anomaly impact score can be the weighted average of the sub-scores. The anomaly impact score can weigh the sub-scores equally or unequally. The anomaly impact score can be a rate represented by a number (e.g., 0 to 1) or a percentage (e.g., 0% to 100%). A high anomaly impact score can indicate a severe anomaly (e.g., a high volume or number of errors, errors that limit the ability of the user to send or transmit network traffic messages to recipients). A low anomaly impact score could indicate a warning that errors or failures can become more common in the future. The anomaly impact score can be an anomaly impact severity score.

The anomaly service 318 can assign the anomaly to a severity bin based on the anomaly impact score, the failure score, the fluctuation score, and the sparsity score (collectively the “scores”). The severity bins can represent or indicate the severity of the anomalies assigned to each respective bin. Each severity bin can have a respective anomaly impact score range such that anomalies with an anomaly impact score falling within that respective anomaly impact score range can be assigned to the respective severity bin. The severity bins can be impact bins. For example, the anomaly service 318 can assign the anomalies with similar anomaly impact scores to the same bin. The scores and the assigned severity bin can be stored in the data store 324 as the anomaly data 327.

The anomaly service 318 can generate and send notifications regarding the anomalies to a user or an account. The anomaly service 318 can include the scores, the assigned severity bin, error metadata, and anomaly metadata (e.g., an indication of the associated user or account, the time period of the anomalies, the scores, and the assigned severity bin) with the notification.

The notification can include a recommendation for addressing and remedying the anomaly. For example, the recommendation can include recommending a change to the network traffic messages or configuration. For example, the recommendation can include proposed solutions or products for remedying the anomaly. The anomaly service 318 can generate recommendations based on user profiles. The anomaly service 318 can generate user profiles based on the anomaly data 327, the configuration data 330, the historical data 333, and the traffic data 335. The anomaly service 318 can determine similarities between the user profiles and generate similarity data.

The anomaly service 318 can generate recommendations for proposed solutions and products based on the user profile data and the similarity data by using a machine learning model or algorithm. The machine learning algorithm or model can be any machine learning algorithm or model or combination thereof, including but not limited to nearest neighbor, support vector machines, gradient boosting, neural networks, logistic regression, linear regression, decision trees, random forest, Naive Bayes, k-means clustering, time series regression, pointwise prediction, stepwise regression, Gaussian mixture models, and means-shift clustering. The model can be any generative artificial learning model or algorithm, including but not limited to generative text models, such as conversational large language foundation models including GPT (“generative pre-training transformer”), including ChatGPT, GPT-4, AlphaCode, GitHub Copilot, Bard, Cohere Generate, Claud, generative image and video models, such as Synthesia and DALL-E 2, and generative audio models. The machine learning model or algorithm can receive solution and product data. The machine learning model or algorithm can use the solution and product data, the user profiles, and the similarity data to generate recommendations for proposed solutions and products. For example, the machine learning model or algorithm can make similar or identical recommendations to similar user profiles based on the similarity data.

The anomaly service 318 can send the notifications based on user configured notification settings. For example, a user can configure the notification settings to only generate and send notifications for anomalies assign to the urgent severity bin. As another example, a user can configure the notification settings to only generate and send notifications if the anomaly impact score falls within a certain range.

The anomaly service 318 can identify and modify a configuration property associated with the anomaly. The configuration property can include any property or parameter associated with one or more network traffic messages. The configuration property can include a filter setting, a network traffic message schedule, a network traffic message sender (e.g., the phone number, email address, or account that will send or transmit the network traffic message), or the recipients (e.g., specific recipients, number of recipients). The configuration property can cause, resolve, or be related to the network traffic message failures, errors, or anomalies. For example, the anomaly service 318 can change a filter setting to remedy the anomaly. As another example, the anomaly service 318 can change the sender to remedy the anomaly. As another example, the anomaly service 318 can modify the schedule or the sender for scheduled or queued network traffic messages.

The training service 321 can train a machine learning model or algorithm to identify anomalies. The machine learning algorithm or model can be any machine learning algorithm or model or combination thereof, including but not limited to nearest neighbor, support vector machines, gradient boosting, neural networks, logistic regression, linear regression, decision trees, random forest, Naive Bayes, k-means clustering, time series regression, pointwise prediction, stepwise regression, Gaussian mixture models, and means-shift clustering. The model can be any generative artificial learning model or algorithm, including but not limited to generative text models, such as conversational large language foundation models including ChatGPT (“generative pre-training transformer”), GPT-4, AlphaCode, GitHub Copilot, Bard, Cohere Generate, Claud, generative image and video models, such as Synthesia and DALL-E 2, and generative audio models.

For example, the model can be a classification model that can classify the network traffic messages in the historical data as anomalies. The model can be any model capable of recognizing patterns in the historical data so that the model can learn to predict and identify anomalies. The model or algorithm can be trained on all of or a portion of the historical data. For example, the model or algorithm can be trained to recognize that an anomaly overlaps with an increase in network traffic message failures. For example, the model or algorithm can be trained to recognize patterns in the network traffic message failures. For example, the model or algorithm can be trained to recognize configuration settings or metadata common to anomalies and network traffic message failures.

The training service 321 can train the model using the historical data, including the historical data 333. The historical data can include previous network traffic messages, including previous network traffic message failures, associated metadata, and user feedback. The historical data can include error metadata and anomaly metadata. The training service 321 can train the model or algorithm to identify anomalies in the historical data.

The training service 321 can analyze the training data set to identify one or more features in the training dataset to distinguish between anomalies and regularities (e.g., network traffic messages that are not anomalies). The features can include failure rates, duration and frequency of failures, correlations between recipients, senders, volume of network traffic messages, filters, among other features. The training service 321 can select one or more of the identified features for use in the machine learning model. The features may be encoded, normalized, or have other preparations performed to convert the selected features into a format for use by the machine learning model. The training service 321 can select and/or generate the machine learning model by determining decisions trees, support vectors, and neural networks, among other algorithms, for use in identifying anomalies. The training service 321 can train the machine learning model using the training data set to identify anomalies based on the identified features.

Once generated, the training service 321 can access the performance of the machine learning model using one or more validation data sets. The validation data sets can include historical data omitted from the training data set and/or included in the training data set. In some embodiments, the validation data can include historic traffic data and historic incident data. The training service 321 can utilize the machine learning model to predict a likelihood of an anomaly and compare the likelihood to result data in the validation data to see if the prediction was accurate.

In some embodiments, the training service 321 can iteratively access the performance of the machine learning model (e.g., daily, weekly, or monthly) based on newly generated data while the machine learning model is being used to identify anomalies. The training service 321 can continue training the machine learning model using the newly generated data. In some embodiments, when the training service 321 identifies a failure rate of identified anomalies exceeds a particular threshold, the training service 321 can retrain or rebuild the machine learning model.

The traffic service provider 309 can be any service capable of sending or transmitting network traffic messages. The traffic service provider 309 can be a service including phone service, including SMS messaging or voice calls, email service, or a messaging application service.

According to various embodiments, the computing device 306 can include any device capable of accessing network 312 including, but not limited to, a computer, smartphone, tablets, or other device. The computing device 306 can include a processor 336 and storage 339. The computing device 306 can include a display 342 on which various user interfaces can be rendered to allow users to configure, monitor, control, and command various functions of networked environment 300. In various embodiments, computing device 306 can include multiple computing devices. Regardless, the computing device 306 can include one or more processors and memory having instructions stored thereon that, when executed by the one or more processors, cause the computing device 306 to perform one, some, or all of the actions, methods, steps, or functionalities provided herein.

The network 312 includes, for example, the Internet, intranets, extranets, wide area networks (WANs), local area networks (LANs), wired networks, wireless networks, or other suitable networks, etc., or any combination of two or more such networks.

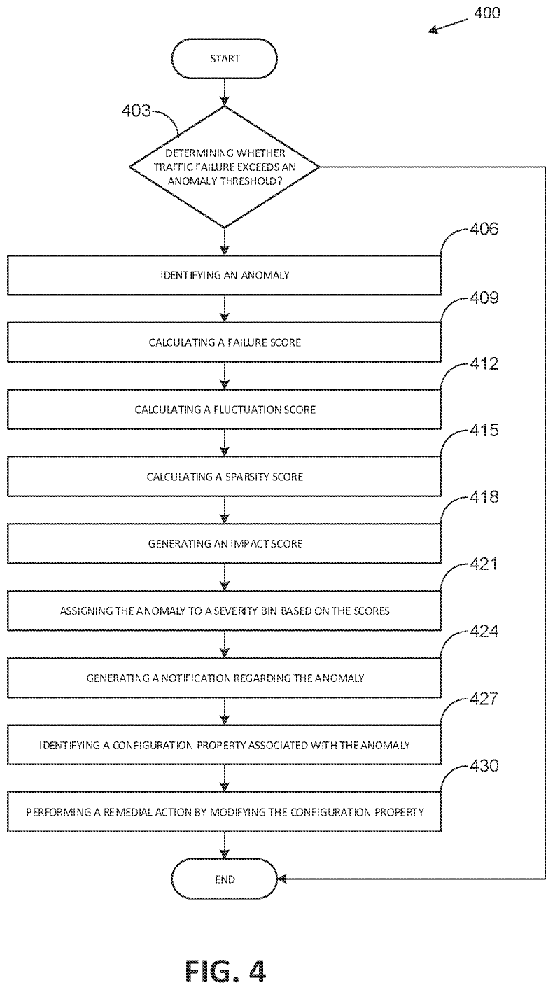

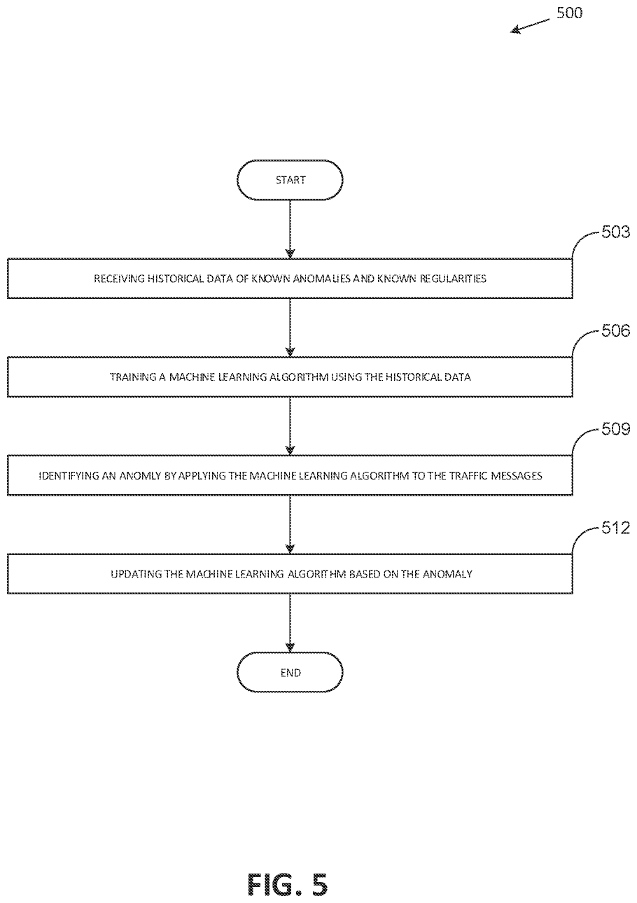

Referring now to FIG. 4, shown is an exemplary, high-level overview process 400 for according to various embodiments of the present disclosure. As will be understood by one having ordinary skill in the art, the steps and processes shown in FIGS. 4 and 5 may operate concurrently and continuously, are generally asynchronous and independent, can be performed in part or in whole by a combination of one or more of the computing environment 303 and computing devices 306, and are not necessarily performed in the order shown and various steps can be executed linearly or in parallel. Process 400 can be performed entirely, partially, or in coordination with the traffic service 315 and anomaly service 318.

At step 403, the process 400 can include determining whether the number of network traffic message failures exceeds an anomaly threshold. The traffic service 315 can determine whether the number of network traffic message failures exceeds an anomaly threshold. The anomaly threshold can be a statistically significant quantity of network traffic message failures over a period of time. The statistically significant quantity of network traffic message failures can be calculated over a period of time (e.g., 1 minute, 5 minutes, 60 minutes, 1 hour, 72 hours, or 336 hours). The anomaly threshold can be associated for each user, each account, each error type (e.g., recipient unreachable, sender blocked, unknown destination, spam, landline, carrier error, filter error, unknown error) or each error code. The anomaly threshold can be calculated based on at least the anomaly data 327, the historical data 333, and the traffic data 335. The anomaly threshold can be received as an input from a user for one or more accounts associated with the user. The anomaly threshold can be determined by the machine learning algorithm discussed in reference to FIG. 5. The number of network traffic message failures can simply exceed the anomaly threshold (e.g., the number of network traffic message failures is greater than the anomaly threshold), exceed the anomaly threshold by one or more standard deviations, or exceed the anomaly threshold be a specified difference. The number of network traffic message failures can be a number of network traffic message failures over a period of time e.g., 15 seconds, 1 minute, 5 minutes, 10 minutes, 60 minutes, 1 hour, 24 hours). The period of time can be a current period of time (e.g., an ongoing period of time or a recent period of time). The period of time can be a current or recent period of time compared to the historical data 333. The network traffic message failures can be included in the traffic data 335. The network traffic message failures can be associated with one or more associated accounts from the same user or different users.

At step 406, the process 400 can include identifying an anomaly. The anomaly service 318 can identify the anomaly. The anomaly can be identified in response to the number of network traffic message failures exceeding the anomaly threshold. Identifying the anomaly can include identifying the user or account associated with the network traffic message failures. Anomalies corresponding to one or more particular network traffic messages can be identified. Identifying the anomaly can include identifying the error type (e.g., recipient unreachable, sender blocked, unknown destination, spam, landline, carrier error, filter error, unknown error) or error code. Identifying the anomaly can include identifying or determining metadata associated with the network traffic failure (e.g., the number of the network traffic failure, the time period of the network traffic failures). Identifying the anomaly can include identifying delays in network traffic messages (e.g., delays in sending, delivery, or receipt of the network traffic messages). Identifying the anomaly can include identifying trends, including patterns in the historic data or current or ongoing network traffic messages relating to volume, changes in volume, and timing of network traffic messages, failures, and errors. The identified anomaly can be stored in the data store 324 as the anomaly data 327.

At step 409, the process 400 can include calculating or determining a failure score for the network traffic messages. The anomaly service 318 can determine the failure score for the network traffic message. The failure score can be the number of network traffic message failures compared to the total number of network traffic messages during a time period. The failure score can represent a failure rate for the network traffic messages. The failure score can be the number of network traffic message failures compared to the number of network traffic message failures in the historical data 333. The failure score can be a rate represented by a number (e.g., 0 to 1) or a percentage (e.g., 0% to 100%). In some embodiments, the failure score can be normalized to fit within a range of values (e.g., 0 to 1 or between 0 and 100). A high failure score can indicate a high number of network traffic message failures compared to the total number of network traffic messages or a historical failure score (e.g., an failure score from the historical data 333). A low failure score can indicate a low number of network traffic message failures compared to the total number of network traffic messages or a historical failure score. The failure score can be determined for a user, an account, an error type, and/or a time period. For example, one error type can have a higher failure score compared to a different error type. The failure score can be stored in the data store 324 as the anomaly data 327.

At step 412, the process 400 can include calculating or determining a fluctuation score for the network traffic messages. The anomaly service 318 can determine the fluctuation score for the network traffic messages. The fluctuation score can be the total number of network traffic messages in a time period. The fluctuation score can be the total number of network traffic messages in a current or recent time period compared to a number of network traffic messages from the historical data 333 (e.g., the total number of network traffic messages are from a current or recent time period and is compared to a number of network traffic messages from a previous or earlier time period). The fluctuation score can be an amount of data sent or transmitted by a user or account. The fluctuation score can be a rate represented by a number (e.g., 0 to 1) or a percentage (e.g., 0% to 100%). In some embodiments, the fluctuation score can be normalized to fit within a range of values (e.g., 0 to 1 or between 0 and 100%). A high fluctuation score can indicate a high number of network traffic message are being sent or transmitted by a user or account. A low fluctuation score can indicate a low number of network traffic messages are being sent or transmitted by a user or account. The fluctuation score can be determined for a user, an account, an error type, and/or a time period. For example, a user can have multiple associated accounts and one account can have a higher fluctuation score than a different account. The fluctuation score can be stored in the data store 324 as the anomaly data 327.

At step 415, the process 400 can include calculating or determining a sparsity score for the network traffic messages. The anomaly service 318 can determine the sparsity score for the network traffic messages. The sparsity score can represent the number of network traffic messages from a previous period of time. The sparsity score can represent the number of network traffic messages from the historical data 333. The sparsity score can be an amount of data sent or transmitted by a user or account during the previous period of time. The sparsity score can be an amount of data sent or transmitted by a user or account. The sparsity score can be a rate represented by a number (e.g., 0 to 1) or a percentage (e.g., 0% to 100%). In some embodiments, the sparsity score can be normalized to fit within a range of values (e.g., 0 to 1 or between 0 and 100). A high sparsity score can indicate a high number of network traffic messages in the historical data 333. A low sparsity score can indicate a low number of network traffic messages in the historical data 333. The sparsity score can be determined for a user, an account, an error type, and/or a time period. For example, a user can have multiple associated accounts and one account can have a higher sparsity score than a different account. The sparsity score can be stored in the data store 324 as the anomaly data 327.

At step 418, the process 400 can include generating an anomaly impact score based on at least the failure score, the fluctuation score, and the sparsity score (collectively the “sub-scores”). The anomaly service 318 can generate the anomaly impact score. The anomaly impact score can be the weighted average of the sub-scores. The anomaly impact score can weigh the sub-scores equally or unequally. The weighting of the sub-scores can be adjusted for each user, account, error type, and/or time period. The weighting of the sub-scores can be received as an input from a user for one or more accounts associated with the user. The weighting of the sub-scores can be determined by the machine learning algorithm discussed in reference to FIG. 5. The sub-scores can be weighted using a machine learning algorithm, including a classification machine learning algorithm. The anomaly impact score can be a rate represented by a number (e.g., 0 to 1) or a percentage (e.g., 0% to 100%). In some embodiments, the anomaly impact can be normalized to fit within a range of values (e.g., 0 to 1 or between 0 and 100). A high anomaly impact score can indicate a severe anomaly (e.g., a high volume or number of errors, errors that limit the ability of the user to send or transmit network traffic messages to recipients). A low anomaly impact score could indicate a warning that errors or failures can become more common in the future. The anomaly impact score can be an anomaly impact severity score. The anomaly impact score can be stored in the data store 324 as the anomaly data 327.

At step 421, the process 400 can include assigning the anomaly to a severity bin based on at least the anomaly impact score, the failure score, the fluctuation score, and the sparsity score (collectively the “scores”). The anomaly service 318 can assign the anomaly to a severity bin. The severity bins can represent or indicate the severity of the anomalies assigned to each respective bin. Each severity bin can have a respective anomaly impact score range such that anomalies with an anomaly impact score falling within that respective anomaly impact score range can be assigned to the respective severity bin. For example, anomalies assigned to the same severity bins can have similar scores, include similar anomaly impact scores. The severity bins can include any number of total severity bins. For example, there can be four severity bins with escalating severity (e.g., warning, important, critical, or urgent). The urgent severity can indicate that a high number of network traffic message failures or other errors that limit a user's ability to send or transmit network traffic messages to recipients. For example, if certain anomalies are assigned to the urgent severity bin, the assignment to the urgent severity bin can indicate that the assigned anomalies should be addressed or prioritized. The warning severity can indicate that a small number of network traffic message failures or that the number of network traffic message failures may being increasing. The severity bins can be impact bins. The assigned severity bin can be stored in the data store 324 as the anomaly data 327.

At step 424, the process 400 can include generating and sending a notification or alert regarding the anomaly. The anomaly service 318 can generate a notification regarding the anomaly. The notification can include the scores (e.g., one or more of the anomaly impact score, the failure score, the fluctuation score, or the sparsity score). The notification can include error metadata including an error code (e.g., an alphanumeric code associated with the error), an error type (e.g., recipient unreachable, sender blocked, unknown destination, spam, landline, carrier error, filter error, or unknown error), an account (e.g., an account associated with a user sending or transmitting the network traffic messages), and instances (e.g., the number of failed network traffic messages). The notification can include anomaly metadata including an indication of the associated user or account, the time period of the anomalies, the scores, and the assigned severity bin. The notification can include a recommendation for addressing and remedying the anomaly. For example, the recommendation can include recommending a change to the network traffic messages. For example, the recommendation can include proposed solutions or products for remedying the anomaly. For example, implementing the proposed solution or product can reduce the severity of the anomaly or volume of errors. The notification can be sent to a user or one or more accounts associated with the user. The notification can be sent to an electronic address provided by the user (e.g., email, phone number). The notification can be stored in the data store 324 as the anomaly data 327.

Users can configure the notifications settings based on the scores or assigned severity bins of the anomalies. For example, a user can configure the notification settings to only generate and send notifications for anomalies assigned to the urgent severity bin. As another example, a user can configure the notification settings to only generate and send notifications if the anomaly impact score falls within a certain range.

At step 427, the process 400 can include identifying a configuration property associated with the anomaly. The anomaly service 318 can identify a configuration property associated with the anomaly. The configuration property can include any property or parameter associated with one or more network traffic messages. The configuration property can include a filter setting, a network traffic message schedule, a network traffic message sender (e.g., the phone number, email address, or account that will send or transmit the network traffic message), or the recipients (e.g., specific recipients, number of recipients). The configuration property can cause, resolve, or be related to the network traffic message failures, errors, or anomalies. For example, a filter setting can cause network traffic message failures. As another example, the sender can be flagged as a spam sender. As another example, the number of recipients can cause the network traffic message to be labeled as spam. The configuration property can be stored in the data store 324 as the configuration data 330.

At step 430, the process 400 can include performing a remedial action by modifying the configuration property. The anomaly service 318 can perform a remedial action by modifying the configuration property. The remedial action can modify the configuration property to resolve or alleviate the anomaly. The remedial action can include changing a filter setting, changing network traffic message sender, or changing the recipients (e.g., changing specific recipients or the number of recipients). For example, if a sender has previously been flagged as a spam sender, then the network traffic message sender can be changed. As an example, if the scheduled network traffic message will fail, the schedule or the sender can be changed. As another example, if a single sender is sending a large number of network traffic messages, multiple senders can be used to send the network traffic messages. The modified configuration property can be stored in the data store 324 as the configuration data 330.

Referring now to FIG. 5, shown is an exemplary process 500 for training a machine learning model using the historical data and applying the machine learning model to the network traffic messages. The process 500 can be performed entirely or partially be the training service 321. At step 503, the process 500 can include receiving the historical data. The training service 321 can receive the historical data. The historical data can include the historical data 333. The historical data can include data related to previous network traffic messages. The historical data can include known anomalies and known regularities. Known anomalies can include previous anomalies in the historical data that have been confirmed as anomalies. Known regularities can include previous network traffic messages that have been confirmed as normal network traffic messages (e.g., not anomalies). The historical data can be labeled to indicate known anomalies and known regularities. The historical data can include error metadata including an error code (e.g., an alphanumeric code associated with the error), an error type (e.g., recipient unreachable, sender blocked, unknown destination, spam, landline, carrier error, filter error, unknown error), an account (e.g., an account associated with a user sending or transmitting the network traffic messages), and instances (e.g., the number of failed network traffic messages). The historical data can include anomaly metadata including an indication of the associated user or account, the time period of the anomalies, the scores, and the assigned severity bin. The historical data can include user feedback. For example, customer feedback can include if an anomaly was correctly identified. The customer feedback can include if a recommendation was helpful or remedied the anomaly. The customer feedback can include feedback regarding the effectiveness of the modified configuration property and the remedial action.

At step 506, the process 500 can include training a machine learning algorithm or model using the received historical data. The training service 321 can train the machine learning algorithm or model using the received historical data. The machine learning algorithm or model can be any machine learning algorithm or model. including but not limited to nearest neighbor, support vector machines, gradient boosting, neural networks, logistic regression, linear regression, decision trees, random forest, Naive Bayes, k-means clustering, time series regression, pointwise prediction, stepwise regression, Gaussian mixture models, and means-shift clustering. The model can be any generative artificial learning model or algorithm, including but not limited to generative text models, such as conversational large language foundation models including ChatGPT (“generative pre-training transformer”), GPT-4, AlphaCode, GitHub Copilot, Bard, Cohere Generate, Claud, generative image and video models, such as Synthesia and DALL-E 2, and generative audio models.

For example, the model can be a classification model that can classify the network traffic messages in the historical data as anomalies. The model can be any model capable of recognizing patterns in the historical data so that the model can learn to predict and identify anomalies. The model or algorithm can be trained on all of or a portion of the historical data. For example, the model or algorithm can be trained to recognize that an anomaly overlaps with an increase in network traffic message failures. For example, the model or algorithm can be trained to recognize patterns in the network traffic message failures. For example, the model or algorithm can be trained to recognize configuration settings or metadata common to anomalies and network traffic message failures.

At step 509, the process 500 can include applying the model or algorithm to the network traffic messages to identify anomalies. The training service 321 can apply the model or algorithm to the network traffic messages to identify anomalies. The model or algorithm can be applied to the current or ongoing network traffic messages or the historical data to identify anomalies. The model or algorithm can be applied to one or more accounts associated with a user to identify anomalies. The identified anomalies can be stored in the data store 324 as anomaly data 327.

The model or algorithm can be applied to the network traffic messages to determine the anomaly threshold. The model or algorithm can determine an anomaly threshold to accurately identify anomalies (e.g., the anomaly threshold can be set such that only the number of network traffic message failures corresponding to an anomaly will exceed the threshold). The model or algorithm can determine the weighting of the sub-scores (e.g., the failure score, the fluctuation score, and the sparsity score). The model or algorithm can determine the weighting of the sub-scores such that anomaly impact scores can be accurately generated. By applying the model or algorithm to the network traffic messages to identify anomalies, determine the anomaly threshold, or determine the weighting of the sub-scores, anomalies can be accurately assigned to severity bins. Accurately assigning anomalies to severity bins can allow users to receive appropriate notifications based on the configured notification settings.

At step 512, the process 500 can include updating or retraining the machine learning algorithm or model based on the anomalies. The training service 321 can update the model based on the identified anomalies. If the identified anomalies differ than the anomalies identified at steps 403 and 406, the model or algorithm can be updated. For example, if an anomaly was not originally identified but the model or algorithm identifies the anomaly in the historical data, the model can be updated so that the model accurately identifies anomalies later. For example, if the anomaly was originally identified but the anomaly threshold can was inaccurate, the model can be updated based on the anomaly threshold. For example, if an anomaly was inaccurately assigned to a severity bin, the model can be updated based on the severity bin. As will be understood by one having ordinary skill in the art, the model can be continuously trained and updated over time.

The model or algorithm can be updated based on batch processing of historical data (e.g., reviewing the network traffic messages from the past 6 hours, 12 hours, 24 hours, 72 hours). The previous network traffic messages can be reviewed to determine if anomalies were accurately identified and assigned to a severity bin. For example, if an anomaly was inaccurately assigned to a severity bin, the model can be updated based on the accurate severity bin.

From the foregoing, it will be understood that various aspects of the processes described herein are software processes that execute on computer systems that form parts of the system. Accordingly, it will be understood that various embodiments of the system described herein are generally implemented as specially-configured computers including various computer hardware components and, in many cases, significant additional features as compared to conventional or known computers, processes, or the like, as discussed in greater detail herein. Embodiments within the scope of the present disclosure also include computer-readable media for carrying or having computer-executable instructions or data structures stored thereon. Such computer-readable media can be any available media which can be accessed by a computer, or downloadable through communication networks. By way of example, and not limitation, such computer-readable media can comprise various forms of data storage devices or media such as RAM, ROM, flash memory, EEPROM, CD-ROM, DVD, or other optical disk storage, magnetic disk storage, solid state drives (SSDs) or other data storage devices, any type of removable non-volatile memories such as secure digital (SD), flash memory, memory stick, etc., or any other medium which can be used to carry or store computer program code in the form of computer-executable instructions or data structures and which can be accessed by a general purpose computer, special purpose computer, specially-configured computer, mobile device, etc.

When information is transferred or provided over a network or another communications connection (either hardwired, wireless, or a combination of hardwired or wireless) to a computer, the computer properly views the connection as a computer-readable medium. Thus, any such connection is properly termed and considered a computer-readable medium. Combinations of the above should also be included within the scope of computer-readable media. Computer-executable instructions comprise, for example, instructions and data which cause a general purpose computer, special purpose computer, or special purpose processing device such as a mobile device processor to perform one specific function or a group of functions.

Those skilled in the art will understand the features and aspects of a suitable computing environment in which aspects of the disclosure may be implemented. Although not required, some of the embodiments of the claimed systems may be described in the context of computer-executable instructions, such as program modules or engines, as described earlier, being executed by computers in networked environments. Such program modules are often reflected and illustrated by flow charts, sequence diagrams, exemplary screen displays, and other techniques used by those skilled in the art to communicate how to make and use such computer program modules. Generally, program modules include routines, programs, functions, objects, components, data structures, application programming interface (API) calls to other computers whether local or remote, etc. that perform particular tasks or implement particular defined data types, within the computer. Computer-executable instructions, associated data structures and/or schemas, and program modules represent examples of the program code for executing steps of the methods disclosed herein. The particular sequence of such executable instructions or associated data structures represent examples of corresponding acts for implementing the functions described in such steps.

Those skilled in the art will also appreciate that the claimed and/or described systems and methods may be practiced in network computing environments with many types of computer system configurations, including personal computers, smartphones, tablets, hand-held devices, multi-processor systems, microprocessor-based or programmable consumer electronics, networked PCs, minicomputers, mainframe computers, and the like. Embodiments of the claimed system are practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

An exemplary system for implementing various aspects of the described operations, which is not illustrated, includes a computing device including a processing unit, a system memory, and a system bus that couples various system components including the system memory to the processing unit. The computer will typically include one or more data storage devices for reading data from and writing data to. The data storage devices provide nonvolatile storage of computer-executable instructions, data structures, program modules, and other data for the computer.

Computer program code that implements the functionality described herein typically comprises one or more program modules that may be stored on a data storage device. This program code, as is known to those skilled in the art, usually includes an operating system, one or more application programs, other program modules, and program data. A user may enter commands and information into the computer through keyboard, touch screen, pointing device, a script containing computer program code written in a scripting language or other input devices (not shown), such as a microphone, etc. These and other input devices are often connected to the processing unit through known electrical, optical, or wireless connections.

The computer that effects many aspects of the described processes will typically operate in a networked environment using logical connections to one or more remote computers or data sources, which are described further below. Remote computers may be another personal computer, a server, a router, a network PC, a peer device or other common network node, and typically include many or all of the elements described above relative to the main computer system in which the systems are embodied. The logical connections between computers include a local area network (LAN), a wide area network (WAN), virtual networks (WAN or LAN), and wireless LANs (WLAN) that are presented here by way of example and not limitation. Such networking environments are commonplace in office-wide or enterprise-wide computer networks, intranets, and the Internet.

When used in a LAN or WLAN networking environment, a computer system implementing aspects of the system is connected to the local network through a network interface or adapter. When used in a WAN or WLAN networking environment, the computer may include a modem, a wireless link, or other mechanisms for establishing communications over the wide area network, such as the Internet. In a networked environment, program modules depicted relative to the computer, or portions thereof, may be stored in a remote data storage device. It will be appreciated that the network connections described or shown are exemplary and other mechanisms of establishing communications over wide area networks or the Internet may be used.

While various aspects have been described in the context of a preferred embodiment, additional aspects, features, and methodologies of the claimed systems will be readily discernible from the description herein, by those of ordinary skill in the art. Many embodiments and adaptations of the disclosure and claimed systems other than those herein described, as well as many variations, modifications, and equivalent arrangements and methodologies, will be apparent from or reasonably suggested by the disclosure and the foregoing description thereof, without departing from the substance or scope of the claims. Furthermore, any sequence(s) and/or temporal order of steps of various processes described and claimed herein are those considered to be the best mode contemplated for carrying out the claimed systems. It should also be understood that, although steps of various processes may be shown and described as being in a preferred sequence or temporal order, the steps of any such processes are not limited to being carried out in any particular sequence or order, absent a specific indication of such to achieve a particular intended result. In most cases, the steps of such processes may be carried out in a variety of different sequences and orders, while still falling within the scope of the claimed systems. In addition, some steps may be carried out simultaneously, contemporaneously, or in synchronization with other steps.

Aspects, features, and benefits of the claimed devices and methods for using the same will become apparent from the information disclosed in the exhibits and the other applications as incorporated by reference. Variations and modifications to the disclosed systems and methods may be effected without departing from the spirit and scope of the novel concepts of the disclosure.

It will, nevertheless, be understood that no limitation of the scope of the disclosure is intended by the information disclosed in the exhibits or the applications incorporated by reference; any alterations and further modifications of the described or illustrated embodiments, and any further applications of the principles of the disclosure as illustrated therein are contemplated as would normally occur to one skilled in the art to which the disclosure relates.

The foregoing description of the exemplary embodiments has been presented only for the purposes of illustration and description and is not intended to be exhaustive or to limit the devices and methods for using the same to the precise forms disclosed. Many modifications and variations are possible in light of the above teaching.

The embodiments were chosen and described in order to explain the principles of the devices and methods for using the same and their practical application so as to enable others skilled in the art to utilize the devices and methods for using the same and various embodiments and with various modifications as are suited to the particular use contemplated. Alternative embodiments will become apparent to those skilled in the art to which the present devices and methods for using the same pertain without departing from their spirit and scope. Accordingly, the scope of the present devices and methods for using the same is defined by the appended claims rather than the foregoing description and the exemplary embodiments described therein. While thresholds are discussed herein as being met when the threshold is exceeded, the system may determine a threshold is met when a value meets or exceeds the threshold.

Clause 1. A system, comprising: a data store comprising a plurality of sets of historic traffic data individually associated with one of a plurality of accounts; and at least one computing device in communication with the data store, the at least one computing device being configured to: identify an anomaly based on metadata associated with a plurality of network traffic messages corresponding to a particular account; determine a failure score for the plurality of network traffic messages representing a rate of failure of the plurality of network traffic messages; determine a fluctuation score for the plurality of network traffic messages based on a change in volume of the plurality of network traffic messages over time; determine a sparsity score by analyzing a quantity of messages delivered over a particular period of time; generate an anomaly impact score based on the failure score, the fluctuation score, and the sparsity score; and assign the anomaly to a particular severity bin of a plurality of severity bins based on the anomaly impact score.

Clause 2. The system of clause 1, wherein the at least one computing device is further configured to generate the anomaly impact score as a weighted average of the failure score, the fluctuation score, and the sparsity score.

Clause 3. The system of clause 1, wherein the at least one computing device is further configured to: identify a configuration property associated with the anomaly based on the data associated with the plurality of network traffic messages; and perform a remedial action comprising modifying the configuration property.

Clause 4. The system of clause 1, wherein the at least one computing device is further configured to identify the anomaly by determining that a count of traffic failures in the data associated with the plurality of network traffic messages exceeds an anomaly threshold associated with the particular account.

Clause 5. The system of clause 1, wherein the at least one computing device is further configured to: receive historical anomaly data comprising a plurality of known anomalies and a plurality of known regularities; train a machine learning algorithm predictive of anomalies using the historical anomaly data; and identify the anomaly based on applying the machine learning algorithm to the data associated with the plurality of network traffic messages corresponding to the particular account.

Clause 6. The system of clause 1, wherein determining the fluctuation score for the plurality of network traffic messages comprises comparing a quantity of the plurality of network traffic messages in a current period of time against at least one quantity of at least one previous period of time.

Clause 7. The system of clause 1, wherein the plurality of network traffic messages comprise at least one network traffic message from at least one additional account associated with the particular account.

Clause 8. A method, comprising: identifying, via one of one or more computing devices, an anomaly based on metadata associated with a plurality of network traffic messages corresponding to a particular account; determining, via one of one or more computing devices, a failure score for the plurality of network traffic messages representing a rate of failure of the plurality of network traffic messages; determining, via one of one or more computing devices, a fluctuation score for the plurality of network traffic messages based on a change in volume of the plurality of network traffic messages; determining, via one of one or more computing devices, a sparsity score by analyzing a quantity of messages delivered over a particular period of time; generating, via one of one or more computing devices, an anomaly impact score based on the failure score, the fluctuation score, and the sparsity score; and assigning, via one of one or more computing devices, the anomaly to a particular severity bin of a plurality of severity bins based on the anomaly impact score.

Clause 9. The method of clause 8, further comprising, via one of one or more computing devices, generating the anomaly impact score as a weighted average of the failure score, the fluctuation score, and the sparsity score.

Clause 10. The method of clause 8, further comprising: identifying, via one of one or more computing devices, a configuration property associated with the anomaly based on the data associated with the plurality of network traffic messages; and perform, via one of one or more computing devices, a remedial action comprising modifying the configuration property.

Clause 11. The method of clause 8, further comprising identifying, via one of one or more computing devices, the anomaly by determining that a count of traffic failures in the data associated with the plurality of network traffic messages exceeds an anomaly threshold associated with the particular account

Clause 12. The method of clause 8, further comprising: receiving, via one of one or more computing devices, historical anomaly data comprising a plurality of known anomalies and a plurality of known regularities; training, via one of one or more computing devices, a machine learning algorithm predictive of anomalies using the historical anomaly data; and identifying, via one of one or more computing devices, the anomaly based on applying the machine learning algorithm to the data associated with the plurality of network traffic messages corresponding to the particular account.

Clause 13. The method of clause 8, wherein determining the fluctuation score for the plurality of network traffic messages comprising comparing, via one of one or more computing devices, a quantity of the plurality of network traffic messages in a current period of time against at least one quantity of at least one previous period of time.

Clause 14. The method of clause 8, wherein the plurality of network traffic messages comprise at least one network traffic message from at least one additional account associated with the particular account.

Clause 15. A non-transitory computer-readable medium embodying a program that, when executed by a computing device, causes the computing device to: identify an anomaly based on metadata associated with a plurality of network traffic messages corresponding to a particular account; determine a failure score for the plurality of network traffic messages representing a rate of failure of the plurality of network traffic messages; determine a fluctuation score for the plurality of network traffic messages based on a change in volume of the plurality of network traffic messages over time; determine a sparsity score by analyzing a quantity of messages delivered over a particular period of time; generate an anomaly impact score based on the failure score, the fluctuation score, and the sparsity score; and assign the anomaly to a particular severity bin of a plurality of severity bins based on the anomaly impact score.

Clause 16. The non-transitory computer-readable medium of clause 15, wherein the program further causes the computing device to: identify a configuration property associated with the anomaly based on the data associated with the plurality of network traffic messages; and perform a remedial action comprising modifying the configuration property.

Clause 17. The non-transitory computer-readable medium of clause 15, wherein the program further causes the computing device to identify the anomaly by determining that a count of traffic failures in the data associated with the plurality of network traffic messages exceeds an anomaly threshold associated with the particular account.

Clause 18. The non-transitory computer-readable medium of clause 15, wherein the program further causes the computing device to: receive historical anomaly data comprising a plurality of known anomalies and a plurality of known regularities; train a machine learning algorithm predictive of anomalies using the historical anomaly data; and identify the anomaly based on applying the machine learning algorithm to the data associated with the plurality of network traffic messages corresponding to the particular account.

Clause 19. The non-transitory computer-readable medium of clause 15, wherein determining the fluctuation score for the plurality of network traffic messages comprises comparing a quantity of the plurality of network traffic messages in a current period of time against at least one quantity of at least one previous period of time.

Clause 20. The non-transitory computer-readable medium of clause 15, wherein the plurality of network traffic messages comprise at least one network traffic message from at least one additional account associated with the particular account.

These and other aspects, features, and benefits of the claims will become apparent from the detailed written description of the aforementioned aspects taken in conjunction with the accompanying drawings, although variations and modifications thereto may be effected without departing from the spirit and scope of the novel concepts of the disclosure.

What is claimed is:

1. A system, comprising:
a data store comprising a plurality of sets of historic traffic data individually associated with one of a plurality of accounts; and
at least one computing device in communication with the data store, the at least one computing device being configured to:
identify an anomaly based on metadata associated with a plurality of network traffic messages corresponding to a particular account;
determine a failure score for the plurality of network traffic messages representing a rate of failure of the plurality of network traffic messages;
determine a fluctuation score for the plurality of network traffic messages based on a change in volume of the plurality of network traffic messages over time;
determine a sparsity score by analyzing a quantity of messages delivered over a particular period of time;
generate an anomaly impact score based on the failure score, the fluctuation score, and the sparsity score; and
assign the anomaly to a particular severity bin of a plurality of severity bins based on the anomaly impact score.

2. The system of claim 1, wherein the at least one computing device is further configured to generate the anomaly impact score as a weighted average of the failure score, the fluctuation score, and the sparsity score.

3. The system of claim 1, wherein the at least one computing device is further configured to:
identify a configuration property associated with the anomaly based on the metadata associated with the plurality of network traffic messages; and
perform a remedial action comprising modifying the configuration property.

4. The system of claim 1, wherein the at least one computing device is further configured to identify the anomaly by determining that a count of traffic failures in the metadata associated with the plurality of network traffic messages exceeds an anomaly threshold associated with the particular account.

5. The system of claim 1, wherein the at least one computing device is further configured to:
receive historical anomaly data comprising a plurality of known anomalies and a plurality of known regularities;
train a machine learning algorithm predictive of anomalies using the historical anomaly data; and
identify the anomaly based on applying the machine learning algorithm to the metadata associated with the plurality of network traffic messages corresponding to the particular account.

6. The system of claim 1, wherein determining the fluctuation score for the plurality of network traffic messages comprises comparing a quantity of the plurality of network traffic messages in a current period of time against at least one quantity of at least one previous period of time.

7. The system of claim 1, wherein the plurality of network traffic messages comprise at least one network traffic message from at least one additional account associated with the particular account.

8. A method, comprising:
identifying, via one of one or more computing devices, an anomaly based on metadata associated with a plurality of network traffic messages corresponding to a particular account;
determining, via one of one or more computing devices, a failure score for the plurality of network traffic messages representing a rate of failure of the plurality of network traffic messages;
determining, via one of one or more computing devices, a fluctuation score for the plurality of network traffic messages based on a change in volume of the plurality of network traffic messages;
determining, via one of one or more computing devices, a sparsity score by analyzing a quantity of messages delivered over a particular period of time;
generating, via one of one or more computing devices, an anomaly impact score based on the failure score, the fluctuation score, and the sparsity score; and
assigning, via one of one or more computing devices, the anomaly to a particular severity bin of a plurality of severity bins based on the anomaly impact score.

9. The method of claim 8, further comprising, via one of one or more computing devices, generating the anomaly impact score as a weighted average of the failure score, the fluctuation score, and the sparsity score.

10. The method of claim 8, further comprising:
identifying, via one of one or more computing devices, a configuration property associated with the anomaly based on the metadata associated with the plurality of network traffic messages; and
perform, via one of one or more computing devices, a remedial action comprising modifying the configuration property.

11. The method of claim 8, further comprising identifying, via one of one or more computing devices, the anomaly by determining that a count of traffic failures in the metadata associated with the plurality of network traffic messages exceeds an anomaly threshold associated with the particular account.

12. The method of claim 8, further comprising:
receiving, via one of one or more computing devices, historical anomaly data comprising a plurality of known anomalies and a plurality of known regularities;
training, via one of one or more computing devices, a machine learning algorithm predictive of anomalies using the historical anomaly data; and
identifying, via one of one or more computing devices, the anomaly based on applying the machine learning algorithm to the metadata associated with the plurality of network traffic messages corresponding to the particular account.

13. The method of claim 8, wherein determining the fluctuation score for the plurality of network traffic messages comprising comparing, via one of one or more computing devices, a quantity of the plurality of network traffic messages in a current period of time against at least one quantity of at least one previous period of time.

14. The method of claim 8, wherein the plurality of network traffic messages comprise at least one network traffic message from at least one additional account associated with the particular account.

15. A non-transitory computer-readable medium embodying a program that, when executed by a computing device, causes the computing device to:
identify an anomaly based on metadata associated with a plurality of network traffic messages corresponding to a particular account;
determine a failure score for the plurality of network traffic messages representing a rate of failure of the plurality of network traffic messages;
determine a fluctuation score for the plurality of network traffic messages based on a change in volume of the plurality of network traffic messages over time;
determine a sparsity score by analyzing a quantity of messages delivered over a particular period of time;
generate an anomaly impact score based on the failure score, the fluctuation score, and the sparsity score; and
assign the anomaly to a particular severity bin of a plurality of severity bins based on the anomaly impact score.

16. The non-transitory computer-readable medium of claim 15, wherein the program further causes the computing device to:
identify a configuration property associated with the anomaly based on the metadata associated with the plurality of network traffic messages; and
perform a remedial action comprising modifying the configuration property.

17. The non-transitory computer-readable medium of claim 15, wherein the program further causes the computing device to identify the anomaly by determining that a count of traffic failures in the metadata associated with the plurality of network traffic messages exceeds an anomaly threshold associated with the particular account.

18. The non-transitory computer-readable medium of claim 15, wherein the program further causes the computing device to:
receive historical anomaly data comprising a plurality of known anomalies and a plurality of known regularities;
train a machine learning algorithm predictive of anomalies using the historical anomaly data; and
identify the anomaly based on applying the machine learning algorithm to the metadata associated with the plurality of network traffic messages corresponding to the particular account.

19. The non-transitory computer-readable medium of claim 15, wherein determining the fluctuation score for the plurality of network traffic messages comprises comparing a quantity of the plurality of network traffic messages in a current period of time against at least one quantity of at least one previous period of time.

20. The non-transitory computer-readable medium of claim 15, wherein the plurality of network traffic messages comprise at least one network traffic message from at least one additional account associated with the particular account.
